(19) United States
(12) Patent Application Publication
(10) Pub. No.: US 2013/0101029 A1
(43) Pub. Date: Apr. 25, 2013

(54) MULTIMEDIA DATA ENCODING

(71) Applicants: Ranga Ramanujam Srinivasan, Villupuram (IN); Mangesh Devidas Sadafale, Nagpur (IN)

(72) Inventors: Ranga Ramanujam Srinivasan, Villupuram (IN); Mangesh Devidas Sadafale, Nagpur (IN)

(73) Assignee: TEXAS INSTRUMENTS INCORPORATED, Dallas, TX (US)

(21) Appl. No.: 13/278,767

(22) Filed: Oct. 21, 2011

(51) Int. Cl. H04N 7/32

(52) U.S. Cl. 375/240.12; 375/E07.243

(57) ABSTRACT

A method of multimedia data encoding and a multimedia data encoding device is provided. The method includes accessing a frame associated with the multimedia data, the frame including a plurality of rows of blocks, each of the plurality of rows including a plurality of blocks. The method also includes reconstructing a first selected block of a first selected row, during a first time slot of a pipeline and a first selected block of a second selected row, during a second time slot of the pipeline. In addition, the method includes determining a first intra prediction mode optimal for intra prediction of the first selected block of the second selected row, during the first time slot of the pipeline, and a second intra prediction mode optimal for intra prediction of a second selected block of the first selected row during the second time slot, based a previously reconstructed block.

### TECHNICAL FIELD

The present disclosure generally relates to the field of multimedia data encoding.

### BACKGROUND

Multimedia data encoding refers to a process of converting multimedia data (e.g. video, image, and the like) from one format to another, for the purposes of standardization, speed, secrecy, security, and saving space. Multimedia data encoding is one of the many processes involved during multimedia compression (e.g. video compression, audio compression, and the like). Multimedia compression involves reducing the size of the multimedia for storage and transmission of multimedia data. The size of multimedia data is reduced by compressing spatial data associated with the multimedia data, and compensating temporal data related to the motion associated with the multimedia data. Exemplary multimedia compression techniques include intra frame compression and/or inter frame compression. Intra frame compression is a form of compression performed using data associated with a frame of the multimedia data and is effectively image compression. In contrast, inter frame compression involves using one or more earlier or later frames in a sequence to compress the frame of the multimedia data. In addition, intra frame compression involves removal of spatial redundancies, and inter frame compression involves removal of spatial as well as temporal redundancies.

The multimedia data is encoded prior to reducing its size. In most of the multimedia compression techniques, a frame of multimedia data is divided into a plurality of blocks of pixels (e.g., macro blocks) in order to encode and/or decode the frame of multimedia data. During multimedia compression, the blocks are encoded using inter prediction and/or intra prediction. Intra prediction of a current block includes encoding the current block using pixels belonging to the blocks spatially adjacent to the current block.

### SUMMARY

A number of exemplary methods and devices for encoding multimedia data are disclosed herein. In an embodiment, a method of multimedia data encoding includes accessing a frame associated with the multimedia data. The frame includes a plurality of rows of blocks. Each of the plurality of rows includes a plurality of blocks. The method also includes reconstructing a first selected block of a first selected row of the plurality of rows, during a first time slot of a pipeline and a first selected block of a second selected row of the plurality of rows, during a second time slot of the pipeline. The first selected row is adjacent to the second selected row. The second selected block of the first selected row is positioned after the first selected block of the first selected row. In addition, the method includes determining a first intra prediction mode optimal for the first selected block of the second selected row, during the first time slot of the pipeline, and a second intra prediction mode optimal for a second selected block of the first selected row during the second time slot of the pipeline. The first intra prediction mode and the second intra prediction mode are determined based on one or more previously reconstructed blocks associated with the first selected row and the second selected row. The plurality of blocks of the first selected row and second selected row are alternately subjected to the reconstruction and the intra prediction mode determination during consecutive time slots of the pipeline to thereby encode the frame.

Additionally, in an embodiment, a multimedia data encoding device is disclosed. The multimedia data encoding device includes an input unit configured to receive the multimedia data for encoding a frame associated with the multimedia data. The frame includes a plurality of rows of blocks. Each of the plurality of rows of blocks includes a plurality of blocks. The multimedia data encoding device also includes a pipeline engine operatively coupled with the input unit and configured to process the plurality of blocks of the frame through a plurality of time slots of a pipeline including a first time slot and a second time slot, for encoding the frame. The pipeline engine includes a reconstruction engine, and an intra prediction mode determination engine coupled with the reconstruction engine. The reconstruction engine is configured to perform reconstruction of a first selected block of a first selected row of the plurality of rows, during the first time slot of the pipeline, and reconstruction of the first selected block of the second selected row during the second time slot of the pipeline. The first selected row is adjacent to the second selected row. The second selected block is subsequent to the first selected block of the first selected row. The intra prediction mode determination engine is configured to determine a first intra prediction mode optimal for performing intra prediction of a first selected block of a second selected row of the plurality of rows during the first time slot of the pipeline. The intra prediction mode determination engine is also configured to determine a second intra prediction mode optimal for performing intra prediction of the second selected block of the first selected row during the second time slot of the pipeline. The first intra prediction mode and the second intra prediction mode are determined based on one or more previously reconstructed blocks associated with the first selected row and/or the second selected row. The plurality of blocks of the first selected row and second selected row are alternately subjected to the reconstruction and the intra prediction mode determination during consecutive time slots of the pipeline for thereby encoding the frame.

Moreover, in an embodiment a computer-readable medium storing a set of instructions that when executed cause a computer to perform a method of multimedia data encoding is disclosed. The method includes accessing a frame including a plurality of rows, each of the plurality of rows including a plurality of blocks. The method also includes reconstructing a first selected block of a first selected row during a first time slot of a pipeline. The method further includes reconstructing the first selected block of the second selected row during a second time slot of the pipeline. In addition the method includes determining a first intra prediction mode optimal for performing intra prediction of a first selected block of a second selected row during the first time slot of the pipeline, the first selected row being adjacent to the second selected row. Moreover the method includes determining a second intra prediction mode optimal for performing intra prediction of a second selected block of the first selected row during the second time slot of the pipeline, the second selected block positioned after the first selected block of the first selected row.

### BRIEF DESCRIPTION OF THE FIGURES

FIG. 1 is a diagrammatic representation of a multimedia data encoding device configured for encoding a frame associated with multimedia data in a pipeline according to an embodiment;

FIG. 2 is a diagrammatic representation of a pipeline engine according to an embodiment;

FIG. 3 is a diagrammatic process flow illustrating the encoding of a frame of multimedia data in a pipeline according to an embodiment;

FIGS. 4A and 4B illustrate an order of intra prediction based encoding of a plurality of blocks of a frame of multimedia data according to an embodiment;

FIGS. 5A and 5B illustrate an exemplary implementation of intra prediction based encoding of a frame associated with multimedia data in a pipeline according to an embodiment; and

FIG. 6 is a flow chart of a method of multimedia data encoding according to an embodiment.

### DETAILED DESCRIPTION

In accordance with an exemplary multimedia compression, a compressed frame may include an intra frame (I-frame), a predicted frame (P-frame), and/or a bi-directional frame (B-frame). An I-frame is obtained by performing intra frame compression. An I-frame includes all of the information to be decoded, and is, in effect, a completely specified frame. A P-frame and a B-frame are obtained by performing inter frame compression and holding a part of data associated with the frame. A P-frame holds data associated with changes in the frame from a preceding frame. The preceding frame may be an I-frame. A B-frame is bi-directionally predicted and utilizes data associated with one or more surrounding I-frames and P-frames during inter frame compression. A B-frame holds data related to differences between the frame and the preceding frame and/or a succeeding frame. The data related to the difference between the frame and the preceding frame and/or the succeeding frame is obtained based on the surrounding I-frames and P-frames. In an exemplary scenario of intra frame compression, the frame associated with multimedia data is divided into a plurality of blocks in order to encode and/or decode the multimedia data. It is noted that the terminology “block” may be construed as referring to an m*n block of pixels within the frame of multimedia data, where m and n are positive integers. An exemplary block is a 16*16 macro block of pixels.

Intra prediction of a subject block of the plurality of blocks is performed using one or more edge pixels associated with a left block and/or a top block, the left block being adjacent and to the left of the subject block and the top block being adjacent to and above the subject block. The one or more edge pixels associated with the left and the top block include one or more edge pixels of a previously reconstructed left block and top block, respectively. An intra prediction mode optimal for performing the intra prediction of the subject block is determined based on the left block and/or the top block. The intra prediction mode determination, intra prediction, and the reconstruction, and/or one or more additional processes involved during the encoding of the block are performed in a pipeline. It is noted that the terminology “pipeline” may be construed as referring to a chain of processes involved during the encoding of a frame that are arranged so that the output of each process is the input of a next process. For example, an output of the reconstruction of the left block is used as an input for intra prediction mode determination of the subject block. The intra prediction mode determination and reconstruction are executed in parallel during a time slot of the pipeline and in a time-sliced manner. If the reconstructed left block is unavailable, an original left block is used for intra prediction mode determination of the block. However, utilizing the original left block during the intra prediction mode determination leads to the creation of noise. In some embodiments, the noise created in the I-frames propagates into the P-frames and the B-frames. The noise causes occurrence of undesirable perceptual artifacts in a decoded frame of multimedia data.

In an exemplary embodiment, a complex sub-macro block level multi-pass is performed between an intra prediction mode determination stage and a reconstruction stage in the pipeline. The occurrence of perceptual artifacts in the decoded frame is avoided via the complex sub-macro block level multi-pass. However the power consumption for implementing the sub-macro block-level multi-pass is high and also the sub-macro block-level multi-pass involves a complex hardware and/or software implementation. In another exemplary embodiment, the intra prediction mode determination is performed by utilizing original left block and certain intra prediction modes that utilize edge pixels of the reconstructed left block under certain conditions are avoided. The noise propagation into the P-frames and the B-frames from the I-frames is prevented, but the noise creation remains. Moreover, utilizing the original left block for intra prediction mode determination involves intensive computation due to the large size of the data associated with the original left block and leads to high power consumption. In yet another exemplary embodiment, the intra prediction mode determination stage and the reconstruction stage are performed in a lock step, thereby making the reconstructed left block available during the intra prediction mode determination stage. However, performing the intra prediction mode determination stage and the reconstruction stage in the lock step leads to a considerable decrease in performance of the pipeline.

In various embodiments of the present technology, the use of high power consuming techniques is minimized while pipeline performance is maintained. Particularly, exemplary embodiments of a method of multimedia data encoding and a multimedia data encoding device are disclosed herein that render the reconstructed left block to be available while determining an intra prediction mode optimal for the subject block without considerably affecting the performance of the pipeline.

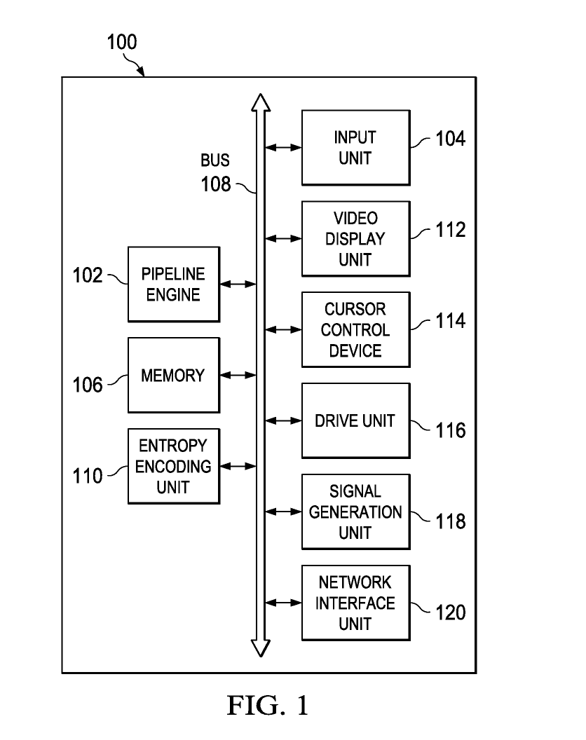

FIG. 1 is a diagrammatic representation of a multimedia data encoding device 100 configured for encoding a frame associated with multimedia data in a pipeline according to an embodiment. Examples of multimedia data include, but are not limited to, video data, image data, and the like. In an embodiment, the multimedia data encoding device 100 is an exemplary form of a computer system within which a set of instructions (for causing the multimedia data encoding device 100 to perform one or more of the methodologies discussed herein) are executed. In various embodiments, the multimedia data encoding device 100 operates as a standalone device and/or is communicatively associated with, coupled with or connected to (e.g., networked) other machines. In one embodiment, in a networked deployment, the multimedia data encoding device 100 operates in the capacity of a server and/or a client machine in a server-client network environment, and/or as a peer machine in a peer-to-peer (or distributed) network environment. Examples of the multimedia data encoding device 100 include, but are not limited to, an image capturing device, a video capturing device, a multimedia encoding device, a personal computer (PC), a tablet PC, a personal digital assistant (PDA), a mobile communication device, a web appliance, a general purpose processor, a digital signal processor, a hard wired control system, a multiprocessor system, a set-top box (STB), an embedded system and/or any machine capable of executing a set of instructions (sequential and/or otherwise) to perform one and/or more of the methodologies discussed herein.

In the present description, a single multimedia data encoding device 100 is illustrated; however, the term “multimedia data encoding device” may also be construed to include any collection of multimedia data encoding devices that individually and/or jointly execute a set (or multiple sets) of instructions to perform one and/or more of the methodologies discussed herein. The multimedia data encoding device 100 may be programmed to comply with video compression standards. Examples of the video compression standards include, but are not limited to, high efficiency video coding (HEVC), H.262 or MPEG-2 Part 2, H.263, H.264 and the like.

The multimedia data encoding device 100 includes a pipeline engine 102 and an input unit 104 (e.g., a camera). The input unit 104 is configured to receive multimedia data to be encoded. The multimedia data includes a plurality of frames such that each frame includes a plurality of blocks. The pipeline engine 102 is operatively coupled with or connected to the input unit 104. Pipeline engine 102 is configurable to process the plurality of blocks of the frame through multiple time slots of a pipeline for encoding the frame of the multimedia data. In some embodiments, the multimedia data encoding device 100 also includes a memory 106. Examples of the memory 106 include, but are not limited to, random access memory (RAM), dual port RAM, synchronous dynamic RAM (SDRAM), double data rate SDRAM (DDR SDRAM), and the like. Pipeline engine 102, the input unit 104, and the memory 106 are configured to communicate with each other via a bus 108. In addition, the multimedia data encoding device 100 also includes an entropy encoding unit 110 configured for encoding the frame of the multimedia data that is previously processed using the pipeline engine 102. Entropy encoding unit 110 is configured to communicate with the pipeline engine 102 and the memory 106 via the bus 108. Entropy encoding unit 110 may also decoupled from the pipeline engine 102.

In an embodiment, the multimedia data encoding device 100 additionally includes a video display unit 112 (e.g., liquid crystals display (LCD), a cathode ray tube (CRT), and the like), a cursor control device 114 (e.g., a mouse), a drive unit 116 (e.g., a disk drive), a signal generation unit 118 (e.g., a speaker) and/or a network interface unit 120. The drive unit 116 includes a machine-readable medium on which is stored one or more sets of instructions (e.g., software) embodying one or more of the methodologies and/or functions described herein. The software resides, either completely or partially, within the memory 106 and/or within the pipeline engine 102 during the execution thereof by the multimedia data encoding device 100, such that the memory 106 and the pipeline engine 102 also constitute a machine-readable media. The software may further be transmitted and/or received over a network via the network interface unit 120. The term “machine-readable medium” may be construed to include a single medium and/or multiple media (e.g., a centralized and/or distributed database, and/or associated caches and servers) that store the one or more sets of instructions. Moreover, the term “machine-readable medium” may be construed to include any medium that is capable of storing, encoding and/or carrying a set of instructions for execution by the multimedia data encoding device 100 and that cause the multimedia data encoding device 100 to perform any one or more of the methodologies of the various embodiments. Furthermore, the term “machine-readable medium” may be construed to include, but shall not be limited to, solid-state memories, optical and magnetic media, and carrier wave signals.

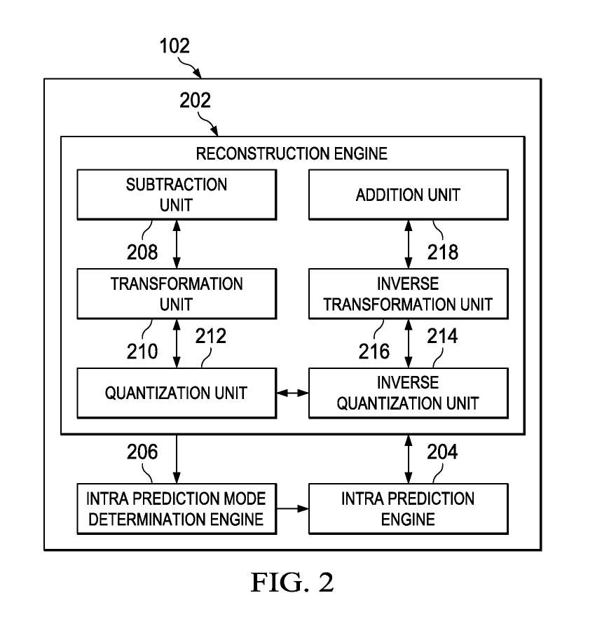

FIG. 2 is a diagrammatic representation of a pipeline engine (e.g., the pipeline engine 102 of the multimedia data encoding device 100 of FIG. 1) according to an embodiment. The pipeline engine 102 includes a reconstruction engine 202, an intra prediction engine 204, and/or an intra prediction mode determination engine 206. In the embodiment of FIG. 2, the pipeline engine 102 is configured to process a frame associated with multimedia data in a pipeline. The frame includes a plurality of rows of blocks such that each of the plurality of rows includes a plurality of blocks. The reconstruction engine 202 and the intra prediction mode determination engine 206 operate in parallel during the multiple consecutive time slots associated with the pipeline. Intra prediction mode determination engine 206 is coupled with and/or connected to the reconstruction engine 202 and/or the intra prediction engine 204. Reconstruction engine 202 is configured to perform a reconstruction of the plurality of blocks within the frame of multimedia data. The intra prediction mode determination engine 206 is configured to determine an intra prediction mode optimal for performing intra prediction of a block (e.g., block succeeding the reconstructed left block) associated with the frame.

The intra prediction engine 204 is configured to perform an intra prediction of one or more blocks of the frame based on the determined intra prediction mode. An output (e.g., a reconstructed left block) of the reconstruction engine 202 is input into the intra prediction mode determination engine 206 to determine the intra prediction mode optimal for the block of the frame based on one or more previously reconstructed blocks associated with the frame. Also the output (e.g., the reconstructed left block) of the reconstruction engine 202 is an input to the intra prediction engine 204 for performing intra prediction of one or more blocks (e.g., blocks succeeding the reconstructed left block) of the frame based on the output. Reconstruction engine 202 and the intra prediction mode determination engine 206 are configured to perform a reconstruction and an intra prediction mode determination respectively, on blocks of different rows (e.g., a first selected row of the plurality of rows and a second selected row of the plurality of rows, respectively, the second selected row being adjacent to and succeeding the first selected row) during each of the multiple time slots of the pipeline.

The reconstruction engine 202 and the intra prediction mode determination engine 206 receive blocks from different rows during consecutive time slots of the pipeline. For example, during a first time slot of the pipeline, the reconstruction engine 202 performs a reconstruction of a block of the first selected row and the intra prediction mode determination engine 206 determines an intra prediction mode optimal for a block of the second selected row. During a second time slot of the pipeline, the reconstruction engine 202 performs a reconstruction of the block of the second selected row and the intra prediction mode determination engine 206 determines another intra prediction mode optimal for another block of the first selected row adjacent to and succeeding the reconstructed block of the first selected row, based on the reconstructed block of the first selected row. The reconstruction engine 202 and the intra prediction mode determination engine 206 thereby receive blocks from alternate rows during consecutive time slots of the pipeline. The intra prediction mode determination engine 206 determines the intra prediction mode based on one or more previously reconstructed blocks. The previously reconstructed blocks include previously reconstructed left blocks. The intra prediction mode determination engine 206 may also determine the intra prediction mode based on an original left block.

Reconstruction engine 202 includes one or more components for performing the reconstruction of blocks. The one or more components include a subtraction unit 208, a transformation unit 210, a quantization unit 212, an inverse quantization unit 214, an inverse transformation unit 216, and an addition unit 218. The subtraction unit 208 is configured to generate a difference between a block and an intra predicted block obtained by performing an intra prediction of the block. In an embodiment, the transformation unit 210 is coupled with and/or connected to the subtraction unit. Transformation unit 210 is configured to transform the difference into a frequency domain. The transform includes, for example, a block transform, an integer transform, an approximate form of the discrete cosine transform (DCT), and the like. Quantization unit 212 is coupled with and/or connected to the transformation unit 210 and is configured to quantize the transformed difference to generate residual data. The residual data includes, but is not limited to, a set of quantized transform coefficients.

The inverse quantization unit 214 is coupled with and/or connected to the quantization unit 212 and is configured to inverse quantize or re-scale the residual data. The inverse transformation unit 216 is coupled with and/or connected to the inverse quantization unit 214. The inverse transformation unit 216 is configured to inverse transform the inverse quantized residual data, into a time domain. The addition unit 218 is coupled with and/or connected to the inverse transformation unit 216 and is configured to add the intra predicted block to the inverse transformed residual data to generate a reconstructed block. For purposes of illustration, this Detailed Description refers to a first selected block, a second selected block, a first selected row, and a second selected row; however, the present technology is not limited to the first selected block, the second selected block, the first selected row, and the second selected row, but rather is extended to include a plurality of blocks and a plurality of rows of blocks.

Entropy encoding unit 110 of the multimedia data encoding device 100 illustrated in FIG. 1 is configured to perform entropy encoding of the residual data to form an encoded frame of multimedia data. The entropy encoded frame includes, for example, an I-frame. Examples of entropy encoding include, but are not limited to, huffman coding, adaptive huffman coding, arithmetic coding, range encoding, Shannon-fano coding, Shannon-fano-elias coding, golomb coding, and the like. Entropy encoding unit 110 is operatively decoupled from the pipeline of the intra prediction mode determination engine 206 and the reconstruction engine 202. Entropy encoding unit 110 performs the entropy encoding in a raster scan order. A time delay is introduced between completion of intra prediction and initiation of entropy encoding. The time delay is introduced during entropy encoding of each of the plurality of rows of blocks associated with the frame of multimedia data. The time delay includes, for example, time duration of intra prediction of one or more blocks of a row of the plurality of rows. The entropy encoding of the one or more blocks of the row is initiated upon completion of intra prediction of the one or more blocks of the row. The encoded residual data is stored in the memory 106 of FIG. 1, along with additional information utilized to decode the block. The additional information includes, for example, an optimal intra prediction mode, a step size for quantization, and the like. In an embodiment, the encoded residual data is compressed to form a compressed bit stream. The compressed bit stream is stored in the memory 106 of FIG. 1.

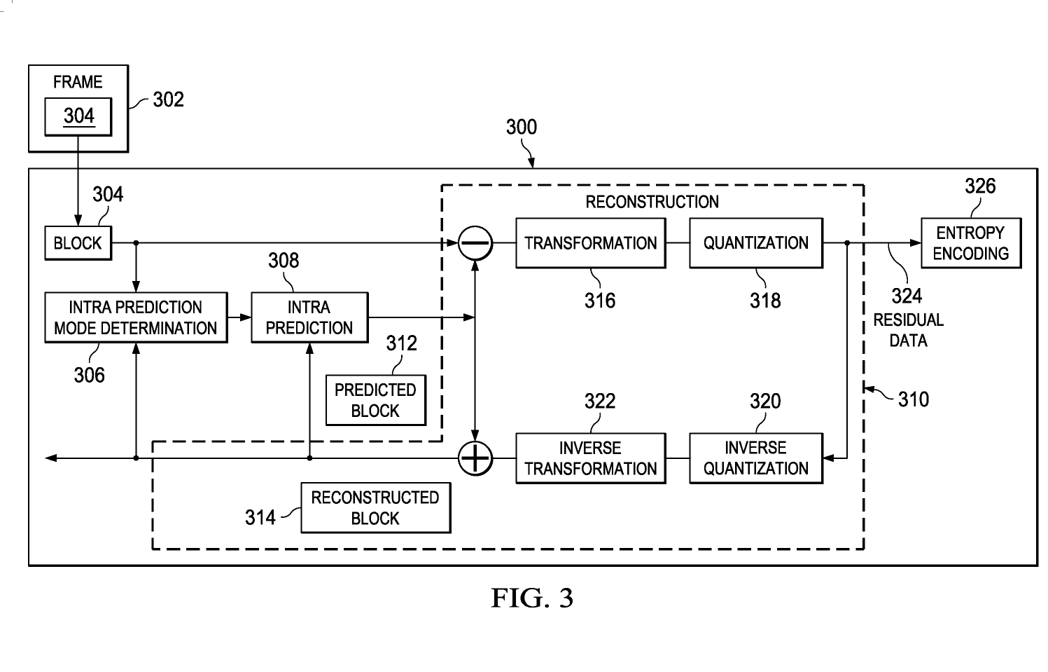

FIG. 3 is a diagrammatic process flow 300 illustrating an encoding of a frame (e.g. a frame 302) of multimedia data in a pipeline, according to an embodiment. The frame 302 includes a plurality of blocks, e.g. a block 304. The encoding of the frame 302 in the pipeline is performed in various stages, such as an intra prediction mode determination stage, an intra prediction stage, and a reconstruction stage. As illustrated in FIG. 3, various stages of the pipeline are shown by means of blocks. For example, the intra prediction mode determination stage is shown by an intra prediction mode determination block 306, the intra prediction stage is shown by an intra prediction block 308, and the reconstruction stage is shown by the reconstruction block 310. As illustrated in FIG. 3, at the mode determination block 306, an intra prediction mode optimal for encoding the block 304 of the frame 302 is determined (e.g. by using the intra prediction mode determination engine 206 of FIG. 2). The intra prediction mode optimal for the block 304 is determined based on a previously reconstructed left block to the left of and adjacent to the block 304. The intra prediction mode is determined based on the consideration of the size of the block 304 and an extent of a distortion of a previously reconstructed left block to the left of and adjacent to the block 304 during reconstruction of the previously reconstructed left block to the left of and adjacent to the block 304. Examples of the intra prediction modes include, but are not limited to, a 4×4 intra prediction mode, an 8×8 intra prediction mode, and a 16×16 intra prediction mode according to luminance components, a mode according to chrominance components, and the like.

At the intra prediction block 308, the block 304 is subjected to intra prediction (e.g., using the intra prediction engine 204 of FIG. 2) based on the determined intra prediction mode for the block 304. The intra prediction of the block 304 is performed using one or more pixels of the previously reconstructed left block to the left of and adjacent to the block 304 to generate a predicted block 312. The one or more pixels includes, for example, one or more edge pixels along an edge common to the block 304 and the reconstructed left block. At the reconstruction block 310, the predicted block 312 is reconstructed (e.g. using the reconstruction engine 202 of FIG. 2) to generate a reconstructed block 314.

In some embodiments, the intra prediction mode determination stage (performed at the intra prediction mode determination block 306) and the reconstruction stage (performed at the reconstruction block 310) are performed in parallel in the pipeline for different rows of blocks of the frame of multimedia data. During consecutive time slots of the pipeline, blocks associated with a pair of rows of blocks are fed into the pipeline while alternating between the adjacent rows in a zigzag pattern. During a time slot of the pipeline, the intra prediction mode determination and the reconstruction are performed simultaneously on blocks from different rows. For example, during a first time slot of the pipeline, a block of a first row of blocks is subjected to intra prediction mode determination and simultaneously a block of a second row of blocks is subjected to reconstruction. During a second time slot of the pipeline, a different block of the second row of blocks is subjected to intra prediction mode determination and simultaneously the block of the first row of blocks is subjected to reconstruction. The reconstructed block of the second row is used for intra prediction mode determination of the different block of the second row and the reconstructed different block of the second row is made available for intra prediction mode determination to be performed subsequently.

The reconstruction stage includes multiple sub-stages, such as a transformation stage, a quantization stage, an inverse quantization stage and an inverse transformation stage. The sub-stages of the reconstruction stage are illustrated as a transformation block 316 for the transformation stage, a quantization block 318 for the quantization stage, an inverse quantization block 320 for the inverse quantization stage and an inverse transformation block 322 for the inverse transformation stage. During the reconstruction stage, the predicted block 312 is subtracted (e.g., by using subtraction unit 208 of FIG. 2) from the block 304 to obtain a difference block. At the transformation block 316, the difference block is transformed (e.g., by using transformation unit 210 of FIG. 2) into a frequency domain using, for example, a block transform, an integer transform, an approximate form of the DCT, and the like. At the quantization block 318, the transformed difference is quantized (e.g., using quantization unit 212) to generate residual data, such as residual data 324. The residual data 324 includes, for example, a set of quantized transform coefficients.

In some embodiments, the residual data 324 is subjected to entropy encoding (e.g., using the entropy encoding unit 110 of FIG. 1) during an entropy encoding stage. The entropy encoding stage is illustrated in FIG. 3 by an entropy encoding block 326. Examples of entropy encoding include, but are not limited to, huffman coding, adaptive huffman coding, arithmetic coding, range encoding, Shannon-fano coding, Shannon-fano-elias coding, golomb coding, and the like. In one embodiment, the entropy encoding is performed in a raster scan pattern. The entropy encoding is performed on the residual data 324 to generate entropy coded residual data. In another embodiment, the entropy coded residual data is buffered (e.g., in memory 106 of FIG. 1) along with additional information utilized to decode the blocks. The additional information includes, for example, an optimal intra prediction mode, a step size for quantization, and the like. The entropy coded residual data is compressed to form a compressed bit stream.

Residual data 324 is decoded during the reconstruction stage. At the inverse quantization block 320 of the reconstruction stage, the residual data 324, including the quantized transform coefficients, is re-scaled through inverse quantization (e.g., using inverse quantization unit 214 of FIG. 2) to obtain inverse quantized residual data. At the inverse transformation block 322 of the reconstruction stage, the inverse quantized residual data is subjected to inverse transformation (e.g., using inverse transformation unit 216 of FIG. 2) to generate a distorted version of the difference block. The distorted version of the difference block is added to the predicted block 312 to create the reconstructed block 314. Reconstructed block 314 is a distorted version of the block 304. Reconstructed block 314 is subsequently used during intra prediction. Reconstructed block 314 may further be filtered (e.g., using a loop filter) prior to being subjected to intra prediction so as to reduce distortion effects.

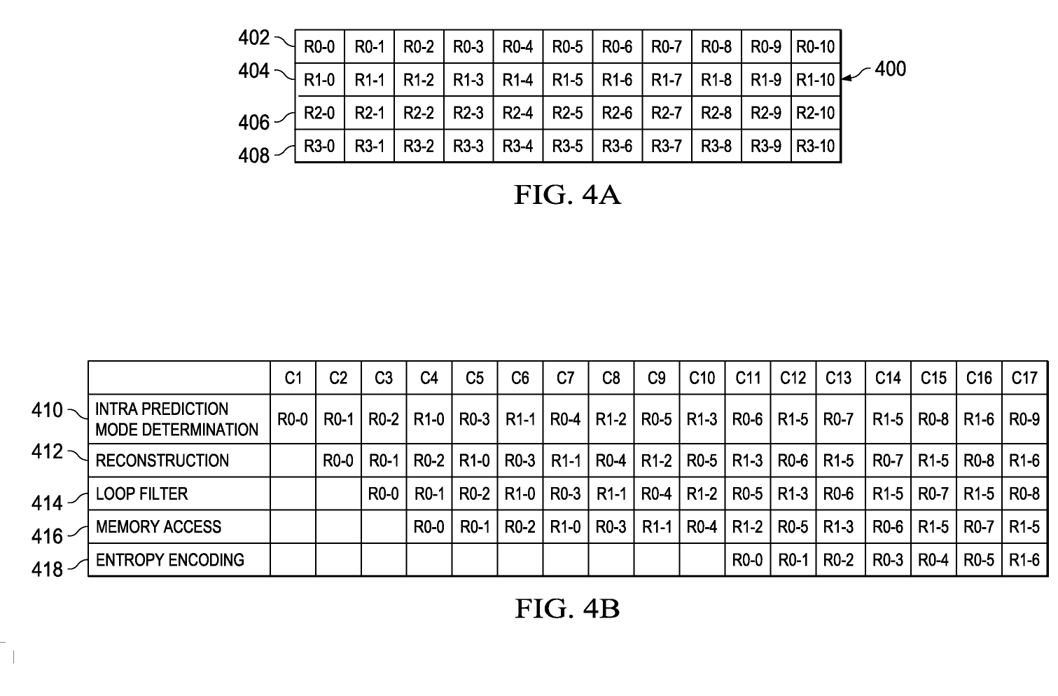

FIGS. 4A and 4B illustrate an order of intra prediction based encoding of a plurality of blocks of a frame of multimedia data performed using the multimedia data encoding device 100 of FIG. 1, according to an embodiment. As illustrated in FIG. 4A, the frame (e.g. a frame 400 of multimedia data) includes a plurality of rows of blocks, such as a first row 402 of blocks R0-0 to R0-10, a second row 404 of blocks R1-0 to R1-10, a third row 406 of blocks R2-0 to R2-10, and a fourth row 408 of blocks R3-0 to R3-10. Also, various stages in a pipeline for the intra prediction based encoding of the blocks are represented as rows 410, 412, 414, 416 and 418 in FIG. 4B. The stages include an intra prediction mode determination stage (row 410), a reconstruction stage (row 412), a loop filter stage (row 414), a memory access stage (row 416), and an entropy encoding stage (row 418). Also illustrated in FIG. 4B are columns C1-C17. The columns C1-C17 corresponding to the rows 410-418 represent multiple time slots of the pipeline during operation of the stages in the pipeline. Consider column C4, and rows 410-418. During a time slot of the pipeline represented by column C4, a block R1-0 of the first row 402 is subjected to intra prediction mode determination (e.g., using the intra prediction mode determination engine 206 of FIG. 2) and simultaneously a block R0-2 of the second row 404 is reconstructed (e.g., using the reconstruction engine 202 of FIG. 2). During a subsequent time slot of the pipeline represented by column C5, a block R0-3 of the first row 402 is subjected to intra prediction mode determination and the block R1-0 of the second row 404 is reconstructed. The block R0-2 is a block to the left of block R0-3 and is utilized for the intra prediction mode determination of the block R0-3.

By reconstructing the block R0-2 before intra prediction mode determination of the block R0-3, a reconstructed block of R0-2 is rendered available for intra prediction mode determination of the block R0-3. In an exemplary embodiment, the pipeline alternates between the consecutive rows (e.g., the first row 402 and the second row 404) during the intra prediction mode determination and the reconstruction, thereby making a left block available for an intra prediction mode determination of each of the blocks within the frame. The reconstructed blocks are loop filtered during subsequent time slots of the pipeline as illustrated in row 414. The loop filtered blocks are buffered through memory access (row 416), including, for example, direct memory access (DMA). A time delay is introduced between completion of the intra prediction mode determination and the initiation of entropy encoding. In an embodiment, the time delay is introduced during entropy encoding of each of the rows of blocks within the frame of multimedia data. The time delay includes, for example, time duration of intra prediction mode determination of one or more blocks of a row. For instance, as illustrated in FIG. 4B, encoding of the blocks of the first row 402 begins during a time slot of the pipeline represented by column C11 and is performed row-wise. Entropy encoding is performed in a raster scan pattern. In an entropy encoding of a row of blocks begins after all of the blocks of the row are subjected intra prediction mode determination.

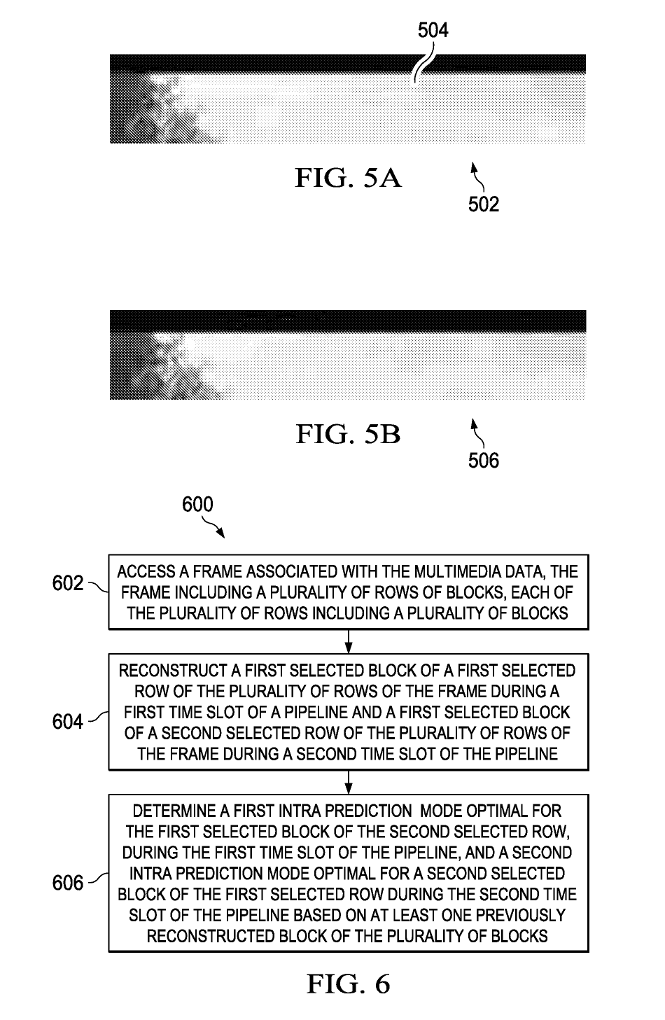

FIGS. 5A and 5B illustrate an exemplary implementation of intra prediction based encoding of a frame associated with multimedia data in a pipeline, according to an embodiment. In some exemplary embodiments, original left blocks are used instead of reconstructed left blocks during intra prediction mode determination. Usage of the original left blocks during intra prediction mode determination creates noise and affects perceptual quality of a decoded frame, peak signal to noise ratio (PSNR) and bit rate. In some embodiments, the noise created originates in an I-frame and propagates to a P-frame and/or a B-frame. FIG. 5A represents a first decoded frame 502 of the frame associated with the multimedia data, which was previously encoded by using original left blocks of the frame. As illustrated in FIG. 5A, the first decoded frame 502 includes a horizontal marking 504 visible to the human eye. The horizontal marking 504 is a perceptual artifact created due to noise creation and propagation during encoding of the frame owing to the usage of original left blocks during encoding.

FIG. 5B represents a second decoded frame 506 associated with the multimedia data, previously encoded according to the disclosed technology. The second decoded frame 506 is obtained by decoding the frame encoded using previously reconstructed left blocks of the blocks associated with the frame during intra prediction mode determination. Using the disclosed technology, the reconstructed left blocks are made available during intra prediction mode determination of each of the blocks of the frame, thereby avoiding the usage of original left blocks and preventing the creation of noise in the second decoded frame 506. As illustrated in FIG. 5B, the second decoded frame 506 is devoid of any undesirable perceptual artifacts (e.g., the horizontal marking 504).

FIG. 6 is a flow chart 600 of a method of multimedia data encoding, according to an embodiment. As illustrated in FIG. 6, in operation 602, a frame associated with the multimedia data is accessed. The frame includes a plurality of rows of blocks, and each of the plurality rows of blocks includes a plurality of blocks. In an embodiment, multimedia data includes a plurality of frames. It is noted that the terminology “block” may be construed as referring to an m*n block of pixels within the frame of multimedia data, where m and n are positive integers. An exemplary block may be a 16*16 macro block of pixels. Examples of the multimedia data include, but are not limited to, video data, image data, and the like. The encoding of the frame of multimedia data is performed through multiple time slots of the pipeline, such as a first time slot (e.g., column C4 and rows 410-418 of FIG. 4B) and a second time slot (e.g., column C5 and rows 410-418 of FIG. 4B). In operation 604, a first selected block (e.g., block R0-2 of column C4, of FIG. 4B) of a first selected row of the plurality of rows is reconstructed (e.g., by using the reconstruction engine 202 of FIG. 2), during the first time slot of the pipeline and a first selected block of a second selected row (e.g., block R1-0 of column C5 of FIG. 4B) of the plurality of blocks is reconstructed during the second time slot of the pipeline. The first selected row is adjacent to the second selected row. The reconstruction of the first selected block of the second selected row is performed in a manner that is substantially similar to the reconstruction of the first selected block of the first selected row.

During reconstruction, a difference between the first selected block of the first selected row and an intra predicted first selected block of the first selected row is generated. The difference is transformed (e.g., using the transformation unit 210 of FIG. 2) into a frequency domain. The difference is transformed using, for example, a block transform, an integer transform, an approximate form of the DCT, and the like. The transformed difference is quantized (e.g., using the quantization unit 212 of FIG. 2) to generate residual data. The residual data is buffered in a memory (e.g., the memory 106 of FIG. 1). The residual data includes, but is not limited to, a set of quantized transform coefficients. The residual data is inverse quantized (e.g., using the inverse quantization unit 214 of FIG. 2) to re-scale the residual data. The inverse quantized residual data is inverse transformed (e.g., using the inverse transformation unit 216 of FIG. 2) into a time domain. The intra predicted first selected block is added (e.g., using the addition unit 218 of FIG. 2) to the inverse transformed residual data to generate a reconstructed first selected block.

In operation 606, a first intra prediction mode optimal for performing an intra prediction of the first selected block of the second selected row (e.g., block R1-0 of column C4 of FIG. 4B) of the plurality of blocks is determined (e.g., using the intra prediction mode determination engine 206 of FIG. 2) during the first time slot of the pipeline and a second intra prediction mode optimal for performing an intra prediction of a second selected block of the first selected row (e.g., block R0-3 of column C5 of FIG. 4B) of the plurality of blocks is determined during the second time slot of the pipeline. The first intra prediction mode and the second intra prediction mode is determined based on a previously reconstructed block associated with the first selected row or the second selected row. The first intra prediction mode or the second intra prediction mode optimal for an initial block associated with the first selected row or the second selected row may also determined based on an original left block associated with the first selected row or the second selected row respectively. The first intra prediction mode may further be determined based on the reconstructed first selected block of the first selected row. Examples of the first intra prediction mode and the second intra prediction mode include, but are not limited to, a 4×4 intra prediction mode, an 8×8 intra prediction mode, and a 16×16 intra prediction mode according to luminance components, a mode according to chrominance components, and the like.

The first intra prediction mode and the second intra prediction mode are specified in a video compression standard. Examples of the video compression standard include, but are not limited to, HEVC, H.262 or MPEG-2 Part 2, H.263, H.264, and the like. An intra prediction of the first selected block of the second selected row is performed based on the determined first intra prediction mode and an intra prediction of the second selected block of the first selected row is performed based on the determined second intra prediction mode. The intra prediction of the first selected block of the second selected row is performed based on one or more previously reconstructed blocks of the second selected row. The intra prediction of the second selected block of the first selected row may also be performed based on the reconstructed first selected block of the first selected row. The intra prediction of the first selected block of the second selected row may further be performed during the first time slot and the intra prediction of the second selected block of the first selected row is performed during the second time slot.

In an embodiment, the reconstruction of the first selected block of the first selected row and determination of the first intra prediction mode are performed in parallel during the first time slot. Also in an embodiment, the reconstruction of the first selected block of the second selected row and determination of the second intra prediction mode are performed in parallel during the second time slot. The plurality of blocks of the first selected row and second selected row are alternately subjected to the reconstruction and the intra prediction mode determination during consecutive time slots of the pipeline to thereby encode the frame. For purposes of illustration, this Detailed Description refers to a first selected block, a second selected block, a first selected row, and a second selected row; however, the present technology is not limited to the first selected block, the second selected block, the first selected row, and the second selected row, but rather is extended to include a plurality of blocks and a plurality of rows of blocks.

In an embodiment, the frame of multimedia data is subjected to entropy encoding (e.g., using the entropy encoding unit 110 of FIG. 1) based on one or more intra predicted blocks (e.g., the intra predicted first selected block of the second selected row and the intra predicted second selected block of the first selected row) of the plurality of blocks to form an encoded frame of multimedia data. The encoded frame of multimedia data includes, for example, an I-frame. Examples of entropy encoding include, but are not limited to, huffman coding, adaptive huffman coding, arithmetic coding, range encoding, Shannon-fano coding, Shannon-fano-elias coding, golomb coding, and the like. In an embodiment the residual data is subjected to entropy encoding to form the encoded frame of multimedia data. The entropy encoding is performed in a raster scan order. A time delay is introduced prior to initiation of the entropy encoding. The time delay is introduced during entropy encoding of each of the rows of blocks within the frame of multimedia data. The time delay includes, for example, the time duration of an intra prediction of one or more blocks of a row. The entropy encoded residual data is stored in the memory along with additional information utilized to decode the entropy encoded frame of multimedia data. The additional information includes, for example, an optimal intra prediction mode, a step size for quantization, and the like. The entropy encoded residual data is compressed to form a compressed bit stream. The compressed bit stream is stored in the memory.

It is noted that a number of embodiments of the present technology is implemented using computer program instructions. For example, the computer program instructions are loaded into a computer, including, but not limited to, a general purpose computer, a special purpose computer, or a programmable data processing apparatus such that the instructions may be executed to implement an embodiment of the present technology. The computer program instructions may also be stored in a computer-readable medium that can direct a computer or other programmable data processing apparatus to function in a particular manner, such that the instructions stored in the computer-readable medium produce an article of manufacture including instructions configured to implement an embodiment of the present technology. The computer program instructions may also be loaded onto a computer or other programmable data processing apparatus to cause a series of operational steps to be performed on the computer or other programmable apparatus to produce a computer implemented process such that the instructions cause an embodiment of the present technology to be implemented.

Without in any way limiting the scope, interpretation, or application of the claims appearing below, advantages of one or more of the exemplary embodiments disclosed herein include the prevention of the usage of original left blocks during an intra prediction mode determination by making available reconstructed left blocks, and thereby preventing the occurrence of undesirable perceptual artifacts in a decoded frame. Preventing the occurrence of undesirable perceptual artifacts in the decoded frame provides better perceptual quality and also prevents propagation of perceptual artifacts into P-frames and B-frames. For instance, during intra prediction based encoding of blocks of the multimedia data according to the present technology, creation of perceptual artifacts (e.g., the horizontal marking 504 of FIG. 5A) is prevented by making available the reconstructed left blocks by alternating between the rows of the blocks of the frame in a zigzag pattern during consecutive time slots of the pipeline. Alternating between the rows makes available the reconstructed left blocks during the intra prediction mode determination without affecting the performance of the pipeline to a considerable extent. A processing time of the pipeline is also utilized effectively by preventing the creation of idle instances of time in the pipeline as the pipeline alternates between the rows of the blocks.

Although the present technology has been described with reference to specific exemplary embodiments, it is noted that various modifications and changes is made to these embodiments without departing from the broad spirit and scope of the present technology. For example, the various devices, modules, analyzers, generators, etc., described herein is enabled and operated using hardware circuitry (e.g., a complementary metal oxide semiconductor (CMOS) based logic circuitry), firmware, software and/or any combination of hardware, firmware, and/or software (e.g., embodied in a machine readable medium). For example, the various electrical structures and methods is embodied using transistors, logic gates, and electrical circuits (e.g., application specific integrated (ASIC) circuitry and/or in Digital Signal Processor (DSP) circuitry).

Particularly, the reconstruction engine 202, the intra prediction engine 204, the intra prediction mode determination engine 206, the pipeline engine 102 of FIG. 2 and/or the entropy encoding unit 110 of FIG. 1 are enabled using software and/or using transistors, logic gates, and electrical circuits (e.g., integrated circuit circuitry such as application specific integrated ASIC circuitry), such as a time counter detector circuit, a pre-processor circuit, a state estimator circuit, a state predictor circuit, a state transition circuit, a decoding circuit, an adder circuit, a subtraction circuit, a processor circuit and/or other circuits.

In addition, it is noted that the various operations, processes, and methods disclosed herein is embodied in a machine-readable medium and/or a machine accessible medium compatible with a data processing system (e.g., a computer system), and is performed in any order (e.g., including using a means for achieving the various operations). Accordingly, the specification and drawings are to be regarded in an illustrative rather than a restrictive sense.

Also, techniques, devices, subsystems and methods described and illustrated in the various embodiments as discrete or separate is combined or integrated with other systems, modules, techniques, or methods without departing from the scope of the present technology. Other items shown or discussed as directly coupled or communicating with each other is coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

What is claimed is:

1. A method of multimedia data encoding comprising:
accessing a frame associated with the multimedia data, the frame comprising a plurality of rows of blocks, each of the plurality of rows comprising a plurality of blocks;
reconstructing a first selected block of a first selected row of the plurality of rows, during a first time slot of a pipeline and a first selected block of a second selected row of the plurality of rows, during a second time slot of the pipeline; and
determining a first intra prediction mode optimal for performing intra prediction of the first selected block of the second selected row, during the first time slot, and a second intra prediction mode optimal for performing intra prediction of a second selected block of the first selected row, during the second time slot, the first selected row being adjacent to the second selected row, the second selected block of the first selected row positioned after the first selected block of the first selected row, the intra prediction mode determination of the first selected block of the second selected row and the second selected block of the first selected row being performed based on at least one previously reconstructed block associated with one of the first selected row and the second selected row, and the plurality of blocks of the first selected row and second selected row being alternately subjected to the reconstruction and the intra prediction mode determination during consecutive time slots of the pipeline to thereby encode the frame.

2. The method of claim 1, wherein the reconstruction of the first selected block of the first selected row and the determination of the first intra prediction mode optimal for the first selected block of the second selected row are performed in parallel, during the first time slot of the pipeline.

3. The method of claim 1, wherein the reconstruction of the first selected block of the second selected row and determination of the second intra prediction mode optimal for the second selected block of the first selected row are performed in parallel, during the second time slot of the pipeline.

4. The method of claim 1, further comprising:
performing intra prediction of the first selected block of the second selected row based on the determined first intra prediction mode and intra prediction of the second selected block of the first selected row based on the determined second intra prediction mode.

5. The method of claim 4, wherein the determined first intra prediction mode and the determined second intra prediction mode are specified in a video compression standard.

6. The method of claim 5, wherein the video compression standard is one of a high efficiency video coding, H.262, H.263, and H.264.

7. The method of claim 1, wherein performing the reconstruction of the first selected block of the first selected row comprises:
transforming a difference between the first selected block of the first selected row and an intra predicted first selected block of the first selected row into a frequency domain;
quantizing the transformed difference to generate residual data;
inverse quantizing the residual data;
inverse transforming the inverse quantized residual data, into a time domain; and
adding the intra predicted first selected block to the inverse transformed residual data to generate a reconstructed first selected block.

8. The method of claim 7, further comprising:
entropy encoding the residual data to generate an encoded frame of multimedia data.

9. The method of claim 8, wherein entropy encoding is decoupled from the pipeline.

10. The method of claim 9, wherein the encoded frame of the multimedia data comprises an intra coded frame.

11. A multimedia data encoding device comprising:
an input unit configured to receive the multimedia data for encoding a frame associated with the multimedia data, the frame comprising a plurality of rows of blocks, each of the plurality of rows of blocks comprising a plurality of blocks; and
a pipeline engine operatively coupled with the input unit and configured to process the plurality of blocks of the frame through a plurality of time slots of a pipeline comprising a first time slot and a second time slot, for encoding the frame, the pipeline engine comprising:
a reconstruction engine, and
an intra prediction mode determination engine coupled with the reconstruction engine,
the reconstruction engine being configured to perform reconstruction of a first selected block of a first selected row of the plurality of rows, during the first time slot of the pipeline, and reconstruction of the first selected block of the second selected row during the second time slot of the pipeline, the intra prediction mode determination engine being configured to determine a first intra prediction mode, during the first time slot of the pipeline, the first intra prediction mode being optimal for performing intra prediction of a first selected block of a second selected row of the plurality of rows, and a second intra prediction mode, during the second time slot of the pipeline, the second intra prediction mode being optimal for performing intra prediction of a second selected block of the first selected row, the first selected row being adjacent to the second selected row, the second selected block of the first row being subsequent to the first selected block of the first selected row,
the first intra prediction mode and the second intra prediction mode being determined based on at least one previously reconstructed block associated with the first selected row and the second selected row respectively, and the plurality of blocks of the first selected row and second selected row being alternately subjected to the first time slot of the pipeline and the second time slot of the pipeline for thereby encoding the frame.

12. The multimedia data encoding device of claim 11, further comprising:
an entropy encoding unit configured to perform an entropy encoding of the frame of the multimedia data based on the reconstruction of the plurality of blocks to form an encoded frame of multimedia data.

13. The multimedia data encoding device of claim 12, wherein the entropy encoding unit is decoupled from the pipeline engine.

14. The multimedia data encoding device of claim 12, wherein the encoded frame of multimedia data comprises an intra coded frame.

15. The multimedia data encoding device of claim 11, wherein the pipeline engine further comprises:
an intra prediction engine configured to perform intra prediction of the first selected block of the second selected row based on the determined first intra prediction mode and intra prediction of the second selected block of the first selected row based on the determined second intra prediction mode.

16. The multimedia data encoding device of claim 11, wherein the reconstruction engine comprises:
a subtraction unit to generate a difference between the first selected block of the first selected row and an intra predicted first selected block of the first selected row;
a transformation unit coupled with the subtraction unit and configured for transforming the difference into a frequency domain; and
a quantization unit coupled with the transformation unit and configured for quantizing the transformed difference to generate residual data.

17. The multimedia data encoding device of claim 16, further comprising:
an inverse quantization unit for inverse quantizing the residual data;
an inverse transformation unit coupled with the inverse quantization unit for inverse transforming the inverse quantized residual data, into a time domain; and
an addition unit coupled with the inverse transformation unit for adding the intra predicted first selected block of the first selected row to the inverse transformed residual data to generate a reconstructed third block.

18. A computer-readable medium storing a set of instructions that when executed cause a computer to perform a method of multimedia data encoding, the method comprising:
accessing a frame associated with the multimedia data, the frame comprising a plurality of rows of blocks, each of the plurality of rows comprising a plurality of blocks;
reconstructing a first selected block of a first selected row of the plurality of rows, during a first time slot of a pipeline and a first selected block of a second selected row of the plurality of rows, during a second time slot of the pipeline; and
determining a first intra prediction mode optimal for performing intra prediction of the first selected block of the second selected row, during the first time slot, and a second intra prediction mode optimal for performing intra prediction of a second selected block of the first selected row, during the second time slot, the first selected row being adjacent to the second selected row, the second selected block of the first selected row positioned after the first selected block of the first selected row, the intra prediction mode determination of the first selected block of the second selected row and the second selected block of the first selected row being performed based on at least one previously reconstructed block associated with the first selected row and the second selected row, and the plurality of blocks of the first selected row and second selected row being alternately subjected to the first time slot of the pipeline and the second time slot of the pipeline to thereby encode the frame.

19. The computer-readable medium of claim 18, wherein the method further comprises:
performing intra prediction of the first selected block of the second selected row based on the determined first intra prediction mode and intra prediction of the second selected block of the first selected row based on the determined second intra prediction mode.

20. The computer-readable medium of claim 18, wherein the method further comprises:
transforming a difference between the first selected block of the first selected row and an intra predicted first selected block of the first selected row, into a frequency domain;
quantizing the transformed difference to generate residual data;
inverse quantizing the residual data;
inverse transforming the inverse quantized residual data, into a time domain; and
adding the intra predicted first selected block of the first selected row to the inverse transformed residual data to generate a reconstructed first selected block.
